(19) United States
(12) Patent Application Publication
(10) Pub. No.: US 2017/0236131 A1
(43) Pub. Date: Aug. 17, 2017

(54) SYSTEM AND METHODS FOR LEVERAGING CUSTOMER AND COMPANY DATA TO GENERATE RECOMMENDATIONS AND OTHER FORMS OF INTERACTIONS WITH CUSTOMERS

(71) Applicant: NETSUITE INC., San Mateo, CA (US)

(72) Inventors: REBECCA WINDT NATHENSON, Menlo Park, CA (US); Joshua Stephen GOODWIN, Las Vegas, NV (US); Rosalina T. KESSMAN, Los Angeles, CA (US); Yukte OBEROI, Santa Clara, CA (US); Allison MANETAKIS, San Mateo, CA (US)

(21) Appl. No.: 15/140,295

(22) Filed: Apr. 27, 2016

Related U.S. Application Data
(60) Provisional application No. 62/154,975, filed on Apr. 30, 2015.

(51) Int. Cl. G06Q 30/02; G06Q 30/06

(52) U.S. Cl. CPC G06Q 30/0201; G06Q 30/0631

(57) ABSTRACT

Embodiments of the inventive system and methods provide the ability to access and process real-time data, such as customer data (e.g., purchase history, browsing history, inquiry history, etc.), inventory data (current levels, in-shipment amounts, in-transit locations, etc.), product margin data (and other financial data, such as sales levels, sales trajectories, revenue, etc.), aggregated customer behavioral data (such as identifying strong influencers, collaborative filtering based associations or correlations, etc.), to provide an integrated shopping experience for end users, such as a vendor's customers.

### CROSS REFERENCE TO RELATED APPLICATION

This application claims the benefit of U.S. Provisional Application No. 62/154,975, entitled “System and Methods for Leveraging Customer and Company Data to Generate Recommendations and Other Forms of Interactions with Customers,” filed Apr. 30, 2015, which is incorporated herein by reference in its entirety (including the Appendix) for all purposes.

### BACKGROUND

Customer relations and customer service are important parts of the relationship between a business and existing or potential customers. Such services may include providing information about products and services in which the customer has shown an interest. However, an important part of operating a business is also helping to identify products that may be of interest to a particular customer. Thus customer relations/service may include helping customers to find items that were previously unknown to them but that are believed to be of possible interest. This type of recommendation or a similar service enables a business' employees (such as salespersons and service representatives) to develop a closer relationship with customers or prospective customers, thereby helping to increase the likelihood that the customer will be satisfied with a purchase. In addition, such services assist the business by improving sales and generating goodwill between the business and customers.

In general, communications between a salesperson/service representative and a customer or potential customer are an important part of how a business develops relationships with the public. Many businesses rely on such communications to market products or services, to develop a deeper relationship with existing customers, to develop potential customers into actual customers, and ultimately to increase sales and improve customer retention. In some situations, such communications can serve as part of a larger customer service strategy for a business and assist in delivering a highly personalized experience to a customer or prospective customer. Typically, such communications may be verbal (via phone or in person) or written and delivered using one of several possible delivery methods (e.g., email, text messaging, or printed materials delivered via regular postal services).

As mentioned, one aspect of personalized or customized customer services and communications is that of providing a customer or prospective customer with a “recommendation” or “suggestion” as to a product or service that may be of interest to them. The recommendation or suggestion may be based on a salesperson's in-store observations of which items a customer looks at, picks up, tries on in a changing room, etc. While this can be useful and effective in some instances, it is imprecise unless there is a reason to believe that the particular salesperson is somehow very adept at selecting or recommending items for that specific customer. This potential problem can be overcome by using a “personal shopper” or an equivalent form of “expert”, but such assistance is typically not available to the casual or less frequent shopper. Realistically, most businesses will only offer a personal shopper to those customers who spend a relatively large amount of money on their products or whose use of the products provides the business with intangible benefits (such as increased brand recognition, valuable publicity, etc.). This means that the customer who spends less or whose use of the products does not provide other benefits to the business may be unable to receive the advice of a personal shopper, stylist, or other form of “expert” who might be best able to recommend a product of interest to the customer.

This situation has generated interest in developing effective ways of making recommendations for customers, where the effectiveness may be measured by a conversion rate or other metric that measures how successful an approach was at causing a customer to make a purchase of the recommended item. Conventional approaches to generating a recommendation are typically based on “mining” transaction data for the customer and/or for a class of which the customer is known to (or expected to) share one or more characteristics, where those characteristics are thought to be relevant to selecting an item or items to recommend.

As an example, statistical analysis, machine learning (supervised or unsupervised), pattern matching, or other analytical methods may be used alone or in combination to identify one or more relevant characteristics shared by a group of purchasers of an item or service. After that, data mining techniques may be used to determine other items that are typically purchased by the members of that group of purchasers. Based on identifying a larger set of products or services that are typically (relatively speaking) purchased by members of the group, a recommendation can be made to a customer who purchased one of the items in the set. The recommendation will consist of items typically purchased (and if it is possible to determine, preferentially purchased) by the group members, and may be based on application of a collaborative filtering methodology.

In this example, by sharing certain characteristics (which are assumed or shown to be relevant) with the other members of the group, the customer is also assumed to have similar product interests (or at least some similar product or service interests). This assumption may be correct or may be in error, but in many cases, it is the best that can be done without knowing more about the relationship between a person's demographic characteristics and their purchasing preferences. This approach to generating a recommendation may also require a significant amount of transaction data in order to validate any particular model or assumptions.

Further, this type of system or process for generating recommendations may not take into account the most desirable customer behavior from a company or vendor's perspective. Given a set of possible customer behaviors to encourage (such as purchase of a sale item, a purchase of a more expensive item, a purchase that might encourage further purchases, a purchase that might assist the customer or the company in reaching a desired goal, etc.), it may be beneficial to a company to identify the most desired customer behavior based upon consideration of the company's inventory, sales, revenue, or other relevant data.

Another problem in generating product recommendations arises because many customers shop on-line using an eCommerce web store and the data available about their on-line purchases may be limited. In such a situation, it would be advantageous to be able to generate recommendations based on more than the on-line purchases and the information about customer preferences that can be extracted from a limited set of transactions, which in some cases may be all that is available. Further, in some cases a business would like to be able to present a recommendation to a customer or prospective customer relatively early in the customer/vendor relationship and not have to wait until sufficient transaction based data is collected. In addition, in some cases, the manner in which a customer or prospective customer is communicated with may either increase or decrease the likelihood of a successful conversion event (i.e., getting the customer to provide the desired response).

Conventional systems for customer relationship management (such as CRM systems) rely on having access to multiple data sources, particularly when it comes to aggregating customer purchasing and/or behavior data, and product availability and location data. This is one factor that is responsible for conventional difficulties in developing an effective system having the structure, benefits and functionality described herein. This is because in the absence of an integrated system that includes both back office and front office/commerce functions, integration of multiple data sources and use of extensive data mapping processes will create both practical and operational problems.

Note that even if multiple data sources are effectively integrated, the overall database typically requires the use of active mapping processes, as integration does not necessarily create a single source of “truth” in the absence of further processing to ensure consistency across all data. Furthermore, integration does not necessarily produce a timely transfer of data. Finally, integration does not guarantee that all relevant sources of data are available for decision-making, as one of the fundamental principles of data science is the discovery of previously-unknown casual or suggestive relationships between disparate pieces of data. Conventional, actively-managed integrations typically result in a situation where a machine-learning system does not have access to certain of the possible data, and as a result may be unable to discover all of the instructive inferences.

Many conventional approaches to providing product or service recommendations for customers, or customer service options for service representatives, draw from a specific subset of the available data, with each approach typically concentrating on a single (and often different) data source. For example, conventional customer relationship management or customer service management solutions provide functionality that draws exclusively from a subset of the data accessed and utilized by embodiments of the inventive system and methods; such conventional systems typically do not access information related to product inventory, warehouse status, in-transit product information, promotional information, sales velocity data, or other sources of potentially relevant information.

As discussed herein, conventional approaches are often confronted with data access, integration, and compatibility issues. In addition, such approaches are generally unable to provide the benefits obtained by using embodiments of the inventive system and methods. Further, conventional approaches lack the ability to identify cross-functional relationships or correlations that may be of interest in generating product recommendations for customers, or in recommending an action for a customer service representative.

As recognized by the inventors, in addition to limitations with regards to the generation of recommendations, conventional solutions provide information or data without a suggestion for what should be done to most effectively use it to generate a sale or to improve the goodwill between a business and a customer. For example, knowing that there's an overstock on a green cashmere sweater is one thing; knowing that a customer tends to browse cashmere sweaters regularly, and has previously purchased items (clothing and perhaps other items) in green is another piece of information. But, knowing both pieces of information, and recommending to a salesperson that they contact the customer to let them know about a sale on cashmere sweaters in a color that they are expected to want is an entirely different approach and a capability lacking in conventional systems. Further, being able to access, process, and evaluate the relevant data in real-time or pseudo real-time, and then generate a recommendation and suggested workflow for a customer service representative to follow, are tasks that are not within the capabilities of conventional systems.

Embodiments of the invention are directed toward solving these and other problems individually and collectively.

### SUMMARY

The terms “invention,” “the invention,” “this invention” and “the present invention” as used herein are intended to refer broadly to all of the subject matter described in this document and to the claims. Statements containing these terms should be understood not to limit the subject matter described herein or to limit the meaning or scope of the claims. Embodiments of the invention covered by this patent are defined by the claims and not by this summary. This summary is a high-level overview of various aspects of the invention and introduces some of the concepts that are further described in the Detailed Description section below. This summary is not intended to identify key, required, or essential features of the claimed subject matter, nor is it intended to be used in isolation to determine the scope of the claimed subject matter. The subject matter should be understood by reference to appropriate portions of the entire specification of this patent, to any or all drawings, and to each claim.

Embodiments of the inventive system, and methods provide the ability to access and process real-time data, such as customer data (e.g., purchase history, browsing history, inquiry history, etc.), inventory data (current levels, in-shipment amounts, in-transit locations, etc.), product margin data (and other financial data, such as sales levels, sales trajectories, revenue, etc.), aggregated customer behavioral data (such as identifying strong influencers, collaborative filtering based associations or correlations, statistical analysis, machine learning to develop models of relevant factors in determining an action, a customer's responsiveness or assumed responsiveness to one or more marketing or data presentation methods, etc.), to provide an integrated shopping experience for end users, such as a vendor's customers.

Embodiments of the inventive system and methods combine access to data at the company level (i.e., vendor, merchant, platform tenant or account, etc.) and at the customer level (i.e., the end user of an eCommerce platform, a vendor's customers, etc.) with appropriate data mining techniques, statistical analysis, supervised or unsupervised machine learning techniques and other relevant analytical methods to transform the data into a process for generating actionable recommendations for companies, customer service representatives, and customers. The combination of access to current data regarding the operational status of a business (including, but not limited to, data such as inventory, sales, profit margins, financials, etc.) and customer-centric data (e.g., browsing history, conversion rates as a function of one or more factors, such as category of items, price range of items, responsiveness to various messaging or data presentation approaches, etc.), in conjunction with the data record format and data base structure used as part of implementing the inventive system, enables improvements in delivering service to customers and in encouraging desired customer behaviors.

In some embodiments, the inventive methods may be implemented as part of an eCommerce platform that is used in conjunction with ERP and/or CRM data as part of a multi-tenant system for providing order management and order processing services for multiple tenant accounts. Typically, such a system or data processing platform may be implemented as a web-service or cloud-based architecture, such as in a Software-as-a-Service (SaaS) model or format.

In one embodiment, the invention is directed to a system for generating a recommendation of a product for a customer or a suggested action for the customer to take, and for providing guidance to a customer service representative regarding the presentation of the recommendation or suggested action to the customer, where the system includes:
a database or data store containing a plurality of records, the plurality of records including records corresponding to customer interactions with an organization providing the products, and records corresponding to the business operations of the organization;
a processor programmed with a set of instructions, wherein when executed by the processor, the instructions cause the system to
   access data representing a status of an aspect of the organization's business operations from the database or data store;
   access data representing a customer's interactions with the organization from the database or data store;
   process the accessed data, including implementing a decision process to generate the recommendation or the suggested action;
   generate a workflow or process for interacting with the customer to enable the organization's representative to present the recommendation or suggested action to the customer; and
   present the workflow or process to the organization's representative.

In another embodiment, the invention is directed to a method for generating a recommendation of a product for a customer or a suggested action for the customer to take, and for providing guidance to a customer service representative regarding the presentation of the recommendation or suggested action to the customer, where the method includes:
accessing data representing a status of an aspect of the organization's business operations from the database or data store;
accessing data representing a customer's interactions with the organization from the database or data store;
processing the accessed data, including implementing a decision process to generate the recommendation or the suggested action;
generating a workflow or process for interacting with the customer to enable the organization's representative to present the recommendation or suggested action to the customer; and
presenting the workflow or process to the organization's representative.

Other objects and advantages of the present invention will be apparent to one of ordinary skill in the art upon review of the detailed description of the present invention and the included figures.

### BRIEF DESCRIPTION OF THE DRAWINGS

Embodiments of the invention in accordance with the present disclosure will be described with reference to the drawings, in which:

FIG. 1 is a diagram illustrating a system, including an integrated business system and an enterprise network in which an embodiment of the invention may be implemented;

FIG. 2 is a diagram illustrating elements or components of an example operating environment in which an embodiment of the invention may be implemented;

FIG. 3 is a diagram illustrating additional details of the elements or components of the multi-tenant distributed computing service platform of FIG. 2, in which an embodiment of the invention may be implemented;

FIG. 4 is a flow chart or flow diagram illustrating a process, method, operation, or function that may be used when implementing an embodiment of the invention; and

FIG. 5 is a diagram illustrating elements or components that may be present in a computer device or system configured to implement a method, process, function, or operation in accordance with an embodiment of the invention.

Note that the same numbers are used throughout the disclosure and figures to reference like components and features.

### DETAILED DESCRIPTION

The subject matter of embodiments of the present invention is described here with specificity to meet statutory requirements, but this description is not necessarily intended to limit the scope of the claims. The claimed subject matter may be embodied in other ways, may include different elements or steps, and may be used in conjunction with other existing or future technologies. This description should not be interpreted as implying any particular order or arrangement among or between various steps or elements except when the order of individual steps or arrangement of elements is explicitly described.

Embodiments of the invention will be described more fully hereinafter with reference to the accompanying drawings, which form a part hereof, and which show, by way of illustration, exemplary embodiments by which the invention may be practiced. This invention may, however, be embodied in many different forms and should not be construed as limited to the embodiments set forth herein; rather, these embodiments are provided so that this disclosure will satisfy the statutory requirements and convey the scope of the invention to those skilled in the art.

Among other things, the present invention may be embodied in whole or in part as a system, as one or more methods, or as one or more apparatuses or devices. Embodiments of the invention may take the form of a hardware implemented embodiment, a software implemented embodiment, or an embodiment combining software and hardware aspects. For example, in some embodiments, one or more of the operations, functions, processes, or methods described herein may be implemented by one or more suitable processing elements (such as a processor, microprocessor, CPU, controller, etc.) that is part of a client device, server, network element, or other form of computing or data processing device/platform and that is programmed with a set of executable instructions (e.g., software instructions), where the instructions may be stored in a suitable data storage element. In some embodiments, one or more of the operations, functions, processes, or methods described herein may be implemented by a specialized form of hardware, such as a programmable gate array, application specific integrated circuit (ASIC), or the like. The following detailed description is, therefore, not to be taken in a limiting sense.

Embodiments of the inventive system, and methods provide the ability to access and process real-time data (or currently available data), such as customer data (e.g., purchase history, browsing history, inquiry history, etc.), inventory data (current levels, in-shipment amounts, in-transit locations, etc.), product margin data (and other financial data, such as sales levels, sales trajectories, revenue, etc.), aggregated customer behavioral data (such as identifying strong influencers, collaborative filtering based associations or correlations, statistical analysis, machine learning to develop models of relevant factors in determining an action, etc.), customer responsiveness to different approaches to presenting information (e.g., fast-to-load, text-heavy pages as compared to slower-to-load, image-rich pages on a web-site), in order to provide an integrated and effective shopping experience for end users, such as a vendor's customers.

As mentioned, embodiments of the inventive system and methods combine access to data at the company level and at the customer-focused level with appropriate data mining techniques, statistical analysis, supervised or unsupervised machine learning techniques, and other relevant analytical methods to transform that data into actionable recommendations for customer service representatives and customers. The recommendations may include not only products that are expected to be of interest to a customer, but also “hints” or a suggested workflow for the service representative that are intended to increase the likelihood of the customer making a purchase or engaging in another desired action.

Conventional approaches are often confronted with data access, integration, and compatibility issues. In addition, such approaches are generally unable to provide the benefits obtained by using embodiments of the inventive system and methods. These benefits include those arising from one or more of (a) synergistic combinations of organizational data or (b) access to a single source of “true” data for all operations within the system (and therefore current and consistent information regarding product types, pricing, availability, options, etc.), (c) real-time data values (as opposed to “batch”) or changes in value (for purposes of data “velocity” or rate based considerations), or (d) more efficient data access capabilities. Further, conventional approaches lack the ability to identify cross-functional relationships or correlations (such as might be indicated by analyzing inventory and data regarding customer responses to different messaging methods) that may be of interest in generating product recommendations for customers, or in recommending an action for a customer service representative.

Omni or multi-channel vendors/merchants desire to provide a seamless, personalized experience for their customers across multiple touch points with that customer, including for example, in-store service, on-line eCommerce, interactions with a call or service center, and email/text communications channels. In some situations, the interactions may include the option of using multiple delivery channels and the associated communications and/or controllable aspects of selecting a delivery channel or conducting tradeoffs between delivery options.

Embodiments of the inventive system and methods provide the capability to access and process real-time data, including customer related data (e.g., purchase history, browsing history, inquiry history, etc.), inventory data (current levels, in-shipment amounts, in-transit locations, etc.), product margin data (and other financial data, such as sales levels, sales trajectories, revenue, etc.), aggregated customer behavioral data (such as identifying strong influencers, collaborative filtering based associations or correlations, statistical analysis, sentiment analysis, or machine learning to develop models of the relevant factors in determining a desired action, etc.), and web-site system data (e.g., page load time, content load order, complexity of content, and other potential tradeoffs between content selection, delivery method, and performance in order to increase conversion rates and customer satisfaction), to provide an integrated shopping experience for end users, such as a vendor's customers.

Embodiments of the inventive system and methods employ various data processing and analysis techniques to generate recommended actions for companies and for their employees (such as customer service or sales representatives) when interacting with customers. The data subjected to processing and analysis is obtained from a database containing data that provides an integrated representation of the current status of the operations of a company (inventory, sales, financials, etc.) and also of its interactions with customers or prospective customers (via multiple channels or points of contact). The database is specifically designed and constructed to serve as a primary source of information regarding the operational status of a company as well as information regarding previous or planned interactions with customers or prospective customers. The customer-related records may include records of contacts, previous browsing and/or purchasing behavior, features accessed on an eCommerce web-site, loyalty program participation, social network behavior, etc. Note that this is in contrast to conventional approaches which typically utilize separate data stores for each primary application or usage (such as ERP, CRM, Financials, Marketing, etc.), and thus prevent an application being able to access and process cross-functional data (and thereby may prevent identification of trends or events that indicate previously undiscovered relationships).

Further, embodiments of the inventive system and methods utilize a record structure that associates each product or service on an eCommerce web-site with its own data record. One result of this approach is that the location, status, or characteristics of an individual item may be determined with accuracy and consistency, whether the record is being accessed in a store, via a web-site, in a warehouse, in-transit, etc.

Among other benefits, by using one or more embodiments of the inventive system and methods, improved customer service and responsiveness can be provided in scenarios such as the following examples:
call center agents processing a refund receive may a recommendation on how to turn that particular customer from a party seeking a refund into a buyer as part of that call;
retail sales representatives may receive customer-specific product recommendations to provide to a previous customer for items that are overstocked, to suggest new products that the customer might like, or because of an upcoming sale that the customer might be interested in knowing about;
retail sales representatives also may receive recommendations regarding the most effective thematic focus/approach to take with a particular customer, based on the customer's response to previous or contemporary messaging techniques via other media channels, such as email and online shopping; for example, a recommendation focusing on a specific brand because the brand is one that the customer has displayed an interest in (as evidenced by their typically clicking on a link regarding that brand when it is presented in an email message or by hovering over an image when it is presented on a web-page); and
a web store manager (i.e., a manager or administrator of an eCommerce web-site) may receive a recommendation regarding a proposed modification to one or more web-pages in order to generate a stronger response from customers (such as increased conversion rates (purchases), increased browsing activity indicating an interest in a displayed product, increased activation of links to related products, etc.). The recommendation(s) may balance product recommendations (data not requested by the shopper) with product data or other information actively requested by the shopper; the approach to page loading and presentation may be modified based on what a shopper responds to most positively (e.g., image vs. text content, a specific layout or format, etc.).

In one embodiment, the inventive system and methods may include one or more of the following data/information and functional capabilities:
All of a vendor's/merchant's/platform-tenant's customer data contained in a structured data storage and access element (such as a database), and associated with (though not necessarily a part of) the customer record(s) and the sales orders. These types/sources of data may include (among others):
   Purchase behavior;
   Customer browsing behavior (hovering, activation of a link, subsequent searches, etc.);
   Third-party-tracked behavior;
   In-store activities;
   Customer service contacts, regardless of channel;
   Previous marketing campaigns and the customer's response to them; and
   Web-page load and performance data; and
Customers/shoppers that are assigned to a given sales associate or set of associates.
   Using these (and in some cases, other) data sources, and leveraging analysis techniques such as machine learning, clustering and predictive segmentation technology, embodiments of the inventive system and methods can provide a sales associate with automatically generated product recommendations. Further, and in contrast to conventional approaches, embodiments of the invention can also provide guidance to the sales representative on how to most effectively interact with the customer (such as by presenting a suggested workflow on their device or “dashboard”), as segmented or divided by customer, the likelihood of a positive response, and the recommended form of action (such as one or more of phone call, e-mail, insertion into customer account, etc.).

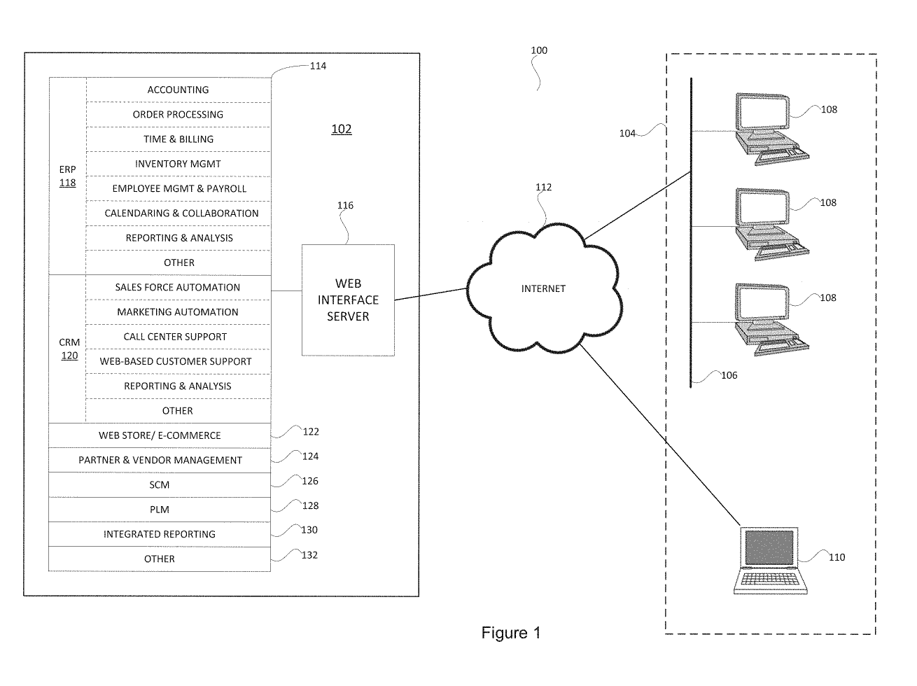

As noted, in some embodiments, the invention may be implemented in the context of a multi-tenant, “cloud” based environment (such as a multi-tenant business data processing platform), typically used to develop and provide (Internet)web-based services and business applications for end users. This exemplary implementation environment will be described with reference to FIGS. 1-3. Note that embodiments of the invention may also be implemented in the context of other computing or operational environments or systems, such as for an individual business data processing system, a private network used with a plurality of client terminals, a remote or on-site data processing system, another form of client-server architecture, etc.

Modern computer networks incorporate layers of virtualization so that physically remote computers and computer components can be allocated to a particular task and then reallocated when the task is done. Users sometimes speak in terms of computing “clouds” because of the way groups of computers and computing components can form and split responsive to user demand, and because users often never see the computing hardware that ultimately provides the computing services. More recently, different types of computing clouds and cloud services have begun emerging.

For the purposes of this description, cloud services may be divided broadly into “low level” services and “high level” services. Low level cloud services (sometimes called “raw” or “commodity” services) typically provide little more than virtual versions of a newly purchased physical computer system: virtual disk storage space, virtual processing power, an operating system, and perhaps a database such as an RDBMS. In contrast, high or higher level cloud services typically focus on one or more well-defined end user applications, such as business oriented applications. Some high level cloud services provide an ability to customize and/or extend the functionality of one or more of the end user applications they provide; however, high level cloud services typically do not provide direct access to low level computing functions.

The ability of business users to access crucial business information has been greatly enhanced by the proliferation of IP-based networking together with advances in object oriented Web-based programming and browser technology. Using these advances, systems have been developed that permit web-based access to business information systems, thereby allowing a user with a browser and an Internet or intranet connection to view, enter, or modify business information. For example, substantial efforts have been directed to Enterprise Resource Planning (ERP) systems that integrate the capabilities of several historically separate business computing systems into a common system, with a view toward streamlining business processes and increasing efficiencies on a business-wide level. By way of example, the capabilities or modules of an ERP system may include (but are not required to include, nor limited to only including): accounting, order processing, time and billing, inventory management, retail point of sale (POS) systems, eCommerce, product information management (PIM), demand/material requirements planning (MRP), purchasing, content management systems (CMS), professional services automation (PSA), employee management/payroll, human resources management, and employee calendaring and collaboration, as well as reporting and analysis capabilities relating to these functions.

In a related development, substantial efforts have also been directed to integrated Customer Relationship Management (CRM) systems, with a view toward obtaining a better understanding of customers, enhancing service to existing customers, and acquiring new and profitable customers. By way of example, the capabilities or modules of a CRM system can include (but are not required to include, nor limited to only including): sales force automation (SFA), marketing automation (including “campaign” management), contact list, call center support, returns management authorization (RMA), loyalty program support, and web-based customer support, as well as reporting and analysis capabilities relating to these functions. With differing levels of overlap with ERP/CRM initiatives and with each other, efforts have also been directed toward development of increasingly integrated partner and vendor management systems, as well as web store/eCommerce, product lifecycle management (PLM), and supply chain management (SCM) functionality.

FIG. 1 is a diagram illustrating a system 100, including an integrated business system 102 and an enterprise network 104 in which an embodiment of the invention may be implemented. Enterprise network 104 may be associated with a business enterprise, such as a retailer, merchant, service provider, or other type of business. Alternatively, and in accordance with the advantages of an application service provider (ASP) hosted integrated business system (such as a multi-tenant data processing platform), the business enterprise may comprise fewer or no dedicated facilities or business network at all, provided that its end users have access to an internet browser and an internet connection. For simplicity and clarity of explanation, the enterprise network 104 is represented by an on-site local area network 106 to which a plurality of personal computers 108 are connected, each generally dedicated to a particular end user (although such dedication is not required), along with an exemplary remote user computer 110 that can be, for example, a laptop computer or tablet computer of a traveling employee having internet access through a hotel, coffee shop, a public Wi-Fi access point, or other internet access method. The end users associated with computers 108 and 110 may also (or instead) possess an internet-enabled smartphone or other electronic device (such as a PDA) having wireless internet access or other synchronization capabilities. Users of the enterprise network 104 interface with the integrated business system 102 across the Internet 112 or another suitable communications network or combination of networks.

Integrated business system 102, which may be hosted by a dedicated third party, may include an integrated business server 114 and a web interface server 116, coupled as shown in FIG. 1. It is to be appreciated that either or both of the integrated business server 114 and the web interface server 116 may be implemented on one or more different hardware systems and components, even though represented as singular units in FIG. 1. In one embodiment, integrated business server 114 comprises an ERP module 118 and further comprises a CRM module 120. In many cases, it will be desirable for the ERP module 118 to share methods, libraries, databases, subroutines, variables, etc., with CRM module 120, and indeed ERP module 118 may be intertwined with CRM module 120 into an integrated Business Data Processing Platform (which may be single tenant, but is typically multi-tenant).

The ERP module 118 may include, but is not limited to, a finance and accounting module, an order processing module, a time and billing module, an inventory management and distribution module, an employee management and payroll module, a calendaring and collaboration module, a reporting and analysis module, and other ERP-related modules. The CRM module 120 may include, but is not limited to, a sales force automation (SFA) module, a marketing automation module, a contact list module (not shown), a call center support module, a web-based customer support module, a reporting and analysis module, and other CRM-related modules. The integrated business server 114 (or multi-tenant data processing platform) further may provide other business functionalities including a web store/eCommerce module 122, a partner and vendor management module 124, and an integrated reporting module 130. An SCM (supply chain management) module 126 and PLM (product lifecycle management) module 128 may also be provided. Web interface server 116 is configured and adapted to interface with the integrated business server 114 to provide one or more web-based user interfaces to end users of the enterprise network 104.

The integrated business system shown in FIG. 1 may be hosted on a distributed computing system made up of at least one, but likely multiple, “servers.” A server is a physical computer dedicated to execute and manage one or more software applications intended to serve the needs of the users of other computers that are in data communication with the server, for instance via a public network such as the Internet or a private “intranet” network. The server, and the services it provides, may be referred to as the “host” and the remote computers, and the software applications running on the remote computers, being served may be referred to as “clients.” Depending on the computing service that a server offers it could be referred to as a database server, file server, mail server, print server, web server, etc. A web server is a most often a combination of hardware and the software that helps deliver content, commonly by hosting a website, to client web browsers that access the web server via the Internet.

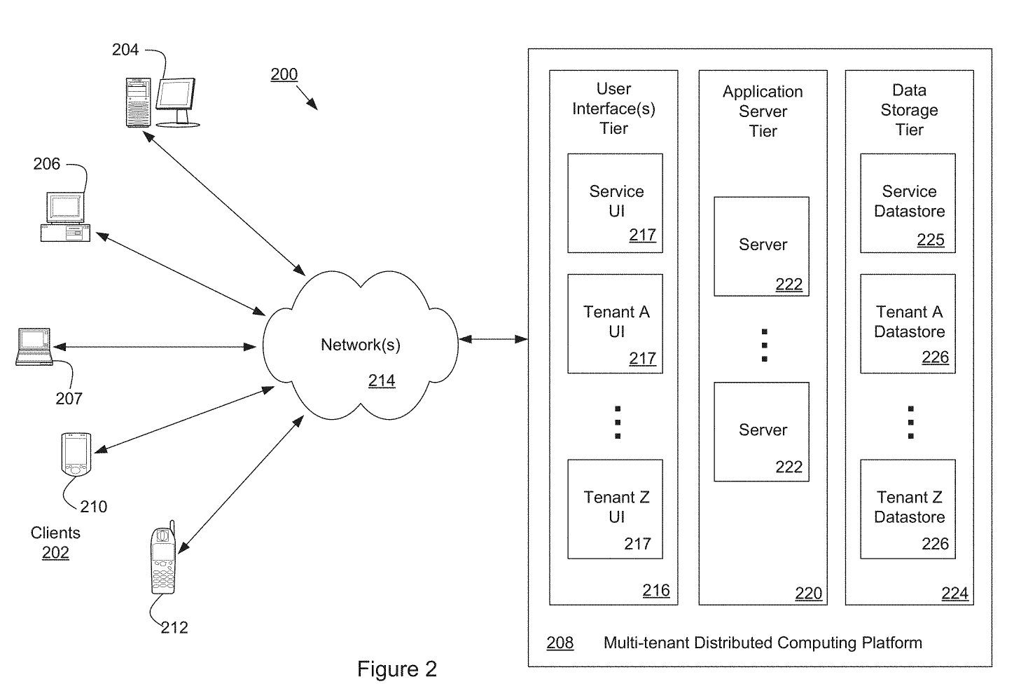

FIG. 2 is a diagram illustrating elements or components of an example operating environment 200 in which an embodiment of the invention may be implemented. As shown, a variety of clients 202 incorporating and/or incorporated into a variety of computing devices may communicate with a distributed computing service/platform 208 through one or more networks 214. For example, a client may incorporate and/or be incorporated into a client application (e.g., software) implemented at least in part by one or more of the computing devices. Examples of suitable computing devices include personal computers, server computers 204, desktop computers 206, laptop computers 207, notebook computers, tablet computers or personal digital assistants (PDAs) 210, smart phones 212, cell phones, and consumer electronic devices incorporating one or more computing device components, such as one or more electronic processors, microprocessors, central processing units (CPU), or controllers. Examples of suitable networks 214 include networks utilizing wired and/or wireless communication technologies and networks operating in accordance with any suitable networking and/or communication protocol (e.g., the Internet).

The distributed computing service/platform (which may also be referred to as a multi-tenant business data processing platform) 208 may include multiple processing tiers, including a user interface tier 216, an application server tier 220, and a data storage tier 224. The user interface tier 216 may maintain multiple user interfaces 217, including graphical user interfaces and/or web-based interfaces. The user interfaces may include a default user interface for the service to provide access to applications and data for a user or “tenant” of the service (depicted as “Service UI” in the figure), as well as one or more user interfaces that have been specialized/customized in accordance with user specific requirements (e.g., represented by “Tenant A UI”, . . . , “Tenant Z UI” in the figure, and which may be accessed via one or more APIs). The default user interface may include components enabling a tenant to administer the tenant's participation in the functions and capabilities provided by the service platform, such as accessing data, causing the execution of specific data processing operations, etc. Each processing tier shown in the figure may be implemented with a set of computers and/or computer components including computer servers and processors, and may perform various functions, methods, processes, or operations as determined by the execution of a software application or set of instructions. The data storage tier 224 may include one or more data stores, which may include a Service Data store 225 and one or more Tenant Data stores 226.

Each tenant data store 226 may contain tenant-specific data that is used as part of providing a range of tenant-specific business services or functions, including but not limited to ERP, CRM, eCommerce, Human Resources management, payroll, etc. Data stores may be implemented with any suitable data storage technology, including structured query language (SQL) based relational database management systems (RDBMS).

In accordance with one embodiment of the invention, distributed computing service/platform 208 may be multi-tenant and service platform 208 may be operated by an entity in order to provide multiple tenants with a set of business related applications, data storage, and functionality. These applications and functionality may include ones that a business uses to manage various aspects of its operations. For example, the applications and functionality may include providing web-based access to business information systems, thereby allowing a user with a browser and an Internet or intranet connection to view, enter, process, or modify certain types of business information.

As noted, such business information systems may include an Enterprise Resource Planning (ERP) system that integrates the capabilities of several historically separate business computing systems into a common system, with the intention of streamlining business processes and increasing efficiencies on a business-wide level. By way of example, the capabilities or modules of an ERP system may include (but are not required to include, nor limited to only including): accounting, order processing, time and billing, inventory management, retail point of sale (POS) systems, eCommerce, product information management (PIM), demand/material requirements planning (MRP), purchasing, content management systems (CMS), professional services automation (PSA), employee management/payroll, human resources management, and employee calendaring and collaboration, as well as reporting and analysis capabilities relating to these functions. Such functions or business applications are typically implemented by one or more modules of software code/instructions that are maintained on and executed by one or more servers 222 that are part of the platform's Application Server Tier 220.

Another business information system that may be provided as part of an integrated data processing and service platform is an integrated Customer Relationship Management (CRM) system, which is designed to assist in obtaining a better understanding of customers, enhance service to existing customers, and assist in acquiring new and profitable customers. By way of example, the capabilities or modules of a CRM system can include (but are not required to include, nor limited to only including): sales force automation (SFA), marketing automation, contact list, call center support, returns management authorization (RMA), loyalty program support, and web-based customer support, as well as reporting and analysis capabilities relating to these functions. In addition to ERP and CRM functions, a business information system/platform (such as element 208 of FIG. 2) may also include one or more of an integrated partner and vendor management system, eCommerce system (e.g., a virtual storefront application or platform), product lifecycle management (PLM) system, Human Resources management system (which may include medical/dental insurance administration, payroll, etc.), or supply chain management (SCM) system. Such functions or business applications are typically implemented by one or more modules of software code/instructions that are maintained on and executed by one or more servers 222 that are part of the platform's Application Server Tier 220.

Note that both functional advantages and strategic advantages may be gained through the use of an integrated business system comprising ERP, CRM, and other business capabilities, as for example where the integrated business system is integrated with a merchant's eCommerce platform and/or “web-store.” For example, a customer searching for a particular product can be directed to a merchant's website and presented with a wide array of product and/or services from the comfort of their home computer, or even from their mobile phone. When a customer initiates an online sales transaction via a browser-based interface, the integrated business system can process the order, update accounts receivable, update inventory databases and other ERP-based systems, and can also automatically update strategic customer information databases and other CRM-based systems. These modules and other applications and functionalities may advantageously be integrated and executed by a single code base accessing one or more integrated databases as necessary, forming an integrated business management system or platform (such as platform 208 of FIG. 2).

As noted with regards to FIG. 1, the integrated business system shown in FIG. 2 may be hosted on a distributed computing system made up of at least one, but typically multiple, “servers.” A server is a physical computer dedicated to execute and manage one or more software applications intended to serve the needs of the users of other computers in data communication with the server, for instance via a public network such as the Internet or a private “intranet” network. The server, and the services it provides, may be referred to as the “host” and the remote computers and the software applications running on the remote computers may be referred to as the “clients.”

Rather than build and maintain such an integrated business system themselves, a business may utilize systems provided by a third party. Such a third party may implement an integrated business system/platform as described above in the context of a multi-tenant platform, wherein individual instantiations of a single comprehensive integrated business system are provided to a variety of tenants. One advantage to such multi-tenant platforms is the ability for each tenant to customize their instantiation of the integrated business system to that tenant's specific business needs or operational methods. Each tenant may be a business or entity that uses the multi-tenant platform to provide business data and functionality to multiple users. Some of those multiple users may have distinct roles or responsibilities within the business or entity.

In some cases, a tenant may desire to modify or supplement the functionality of an existing platform application by introducing an extension to that application, where the extension is to be made available to the tenant's employees and/or customers. In some cases such an extension may be applied to the processing of the tenant's business related data that is resident on the platform. The extension may be developed by the tenant or by a 3^{rd} party developer and then made available to the tenant for installation. The platform may include a “library” or catalog of available extensions, which can be accessed by a tenant and searched to identify an extension of interest. Software developers may be permitted to “publish” an extension to the library or catalog after appropriate validation of a proposed extension.

Thus, in an effort to permit tenants to obtain the services and functionality that they desire (which may include providing certain services to their end customers, such as functionality associated with an eCommerce platform), a multi-tenant service platform may permit a tenant to configure certain aspects of the available service(s) to better suit their business needs. In this way aspects of the service platform may be customizable, and thereby enable a tenant to configure aspects of the platform to provide distinctive services and functionality to their respective users or to groups of those users. For example, a business enterprise that uses the service platform may want to provide additional functions or capabilities to their employees and/or customers, or to cause their business data to be processed in a specific way in accordance with a defined workflow that is tailored to their business needs, etc.

Tenant customizations to the platform may include custom functionality (such as the capability to perform tenant or user-specific functions, data processing, or operations) built on top of lower level operating system functions. Some multi-tenant service platforms may offer the ability to customize functions or operations at a number of different levels of the service platform, from aesthetic modifications to a graphical user interface to providing integration of components and/or entire applications developed by independent third party vendors. This can be very beneficial, since by permitting use of components and/or applications developed by third party vendors, a multi-tenant service can significantly enhance the functionality available to tenants and increase tenant satisfaction with the platform.

As noted, in addition to user customizations, an independent software developer may create an extension to a particular application that is available to users through a multi-tenant data processing platform. The extension may add new functionality or capabilities to the underlying application. One or more tenants/users of the platform may wish to add the extension to the underlying application in order to be able to utilize the enhancements to the application that are made possible by the extension. Further, the developer may wish to upgrade or provide a patch to the extension as they recognize a need for fixes or additional functionality that would be beneficial to incorporate into the extension. In some cases the developer may prefer to make the upgrade available to only a select set of users (at least initially) in order to obtain feedback for improving the newer version of the extension, to test the stability of the extension, or to assist them to segment the market for their extension(s).

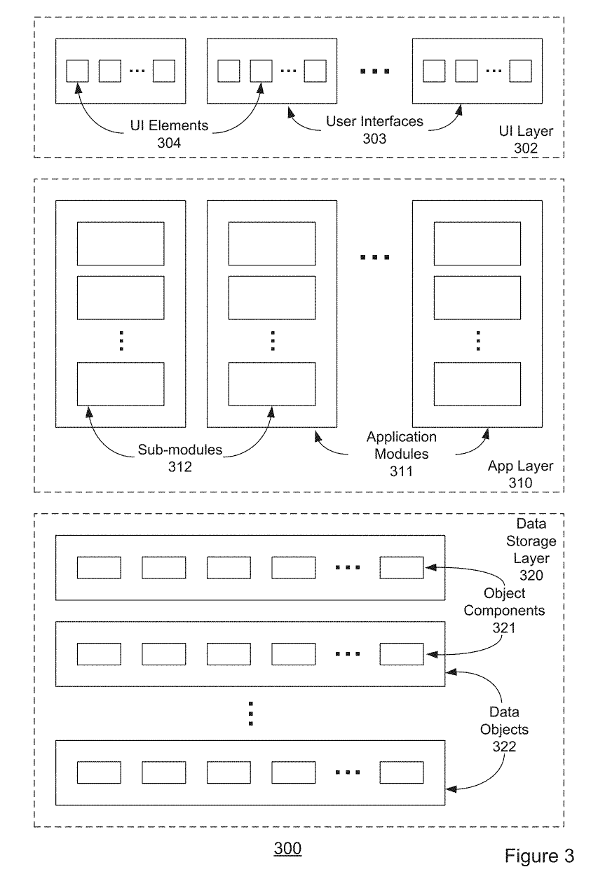

FIG. 3 is a diagram illustrating additional details of the elements or components of the multi-tenant distributed computing service platform of FIG. 2, in which an embodiment of the invention may be implemented. The software architecture depicted in FIG. 2 represents an example of a complex software system to which an embodiment of the invention may be applied. In general, an embodiment of the invention may be implemented using a set of software instructions that are designed to be executed by a suitably programmed processing element (such as a CPU, microprocessor, processor, controller, computing device, etc.). In a complex system such instructions are typically arranged into “modules” with each such module performing a specific task, process, function, or operation. The entire set of modules may be controlled or coordinated in their operation by an operating system (OS) or other form of organizational platform.

As noted, FIG. 3 is a diagram illustrating additional details of the elements or components 300 of the multi-tenant distributed computing service platform of FIG. 2, in which an embodiment of the invention may be implemented. The example architecture includes a user interface layer or tier 302 having one or more user interfaces 303. Examples of such user interfaces include graphical user interfaces and application programming interfaces (APIs). Each user interface may include one or more interface elements 304. For example, users may interact with interface elements in order to access functionality and/or data provided by application and/or data storage layers of the example architecture. Examples of graphical user interface elements include buttons, menus, checkboxes, drop-down lists, scrollbars, sliders, spinners, text boxes, icons, labels, progress bars, status bars, toolbars, windows, hyperlinks and dialog boxes. Application programming interfaces may be local or remote, and may include interface elements such as parameterized procedure calls, programmatic objects and messaging protocols.

The application layer 310 may include one or more application modules 311, each having one or more sub-modules 312. Each application module 311 or sub-module 312 may correspond to a particular function, method, process, or operation that is implemented by the module or sub-module (e.g., a function or process related to providing ERP, CRM, eCommerce or other functionality to a user of the platform). Such function, method, process, or operation may also include those used to implement one or more aspects of the inventive system and methods, such as for:
Accessing or receiving data representing a real-time or pseudo real-time status of one or more aspects of an organization's business operations, including but not limited to inventory, sales, sales velocity, profit margin, etc.;
Accessing or receiving data representing a customer's current browsing activities, order status, previous browsing or purchase activities, loyalty group memberships, responsiveness to different means of contact or presentation of information, etc.;
Enabling multiple applications and/or data processing operations to access the same database and data structures, thereby ensuring that the applications and organizational representatives base decisions upon the same (and current) information;
If desired, generating a suggested workflow or customer-interaction process to enable an organization's representatives to more effectively interact with a customer based on known or derived information about the customer, the organization's inventory or sales, etc.; and
Implementing one or more decision processes (based on one or more of a rule set, statistical analysis, pattern matching, sentiment analysis, machine learning, etc.) to generate a product or service recommendation, or a suggested action that is expected to be of interest to a customer.

The application modules and/or sub-modules may include any suitable computer-executable code or set of instructions (e.g., as would be executed by a suitably programmed processor, microprocessor, or CPU), such as computer-executable code corresponding to a programming language. For example, programming language source code may be compiled into computer-executable code. Alternatively, or in addition, the programming language may be an interpreted programming language such as a scripting language. Each application server (e.g., as represented by element 222 of FIG. 2) may include each application module. Alternatively, different application servers may include different sets of application modules. Such sets may be disjoint or overlapping.

The data storage layer 320 may include one or more data objects 322 each having one or more data object components 321, such as attributes and/or behaviors. For example, the data objects may correspond to tables of a relational database, and the data object components may correspond to columns or fields of such tables. Alternatively, or in addition, the data objects may correspond to data records having fields and associated services. Alternatively, or in addition, the data objects may correspond to persistent instances of programmatic data objects, such as structures and classes. Each data store in the data storage layer may include each data object. Alternatively, different data stores may include different sets of data objects. Such sets may be disjoint or overlapping.

Note that the example computing environments depicted in FIGS. 1-3 are not intended to be limiting examples. Alternatively, or in addition, computing environments in which an embodiment of the invention may be implemented include any suitable system that permits users to provide data to, and access, process, and utilize data stored in a data storage element (e.g., a database) that can be accessed remotely over a network. Further example environments in which an embodiment of the invention may be implemented include devices (including mobile devices), software applications, systems, apparatuses, networks, or other configurable components that may be used by multiple users for data entry, data processing, application execution, data review, etc. and which have user interfaces or user interface components that can be configured to present an interface to a user. Although further examples below may reference the example computing environment depicted in FIGS. 1-3, it will be apparent to one of skill in the art that the examples may be adapted for alternate computing devices, systems, apparatuses, processes, and environments. Note that an embodiment of the inventive methods may be implemented in the form of an application, a sub-routine that is part of a larger application, a “plug-in”, an extension to the functionality of a data processing system or platform, or any other suitable form.

As mentioned, in some embodiments, an important feature of the inventive system and methods is that the data used to represent the real-time (or substantially real-time) status of the organization is the same as that used by customers to browse inventory and to conduct purchase transactions. This arrangement prevents the need to utilize multiple data sources in order to obtain an accurate and complete representation of the organization's inventory and product availability, along with information about customer interactions with the organization (which would require administrative overhead to ensure that the multiple data sources are consistent and/or properly integrated).

Note that the inventive system or platform provides this and other benefits or advantages at least partially as a result of the underlying data schema and database structure. One implication of this architecture is that when a customer goes into a store, the product information brought up by the sales associate is the same data (i.e., the same instance of a product or product line) as a customer would find if they visited the organization's eCommerce web-site. For example, the barcode that a sales associate scans in a physical store setting will bring up the same record and information (i.e., the same fields and values in the database) as viewing the item on-line in the web-store would provide. The same is true for a customer service representative; the item they view in the back end of the customer service system is the same item as the one the store representative sees, and also the same one as an eCommerce shopper sees.

As a result of the data structure and platform architecture utilized in some embodiments of the inventive system and methods, data such as item description, inventory level, profit margin, vendor/supplier, etc., are sourced from the same database or data storage location(s) regardless of the origin of the information request. This means that any application or user seeking certain data will access the data from a singular location in the database. Consequently, inventory data for warehouses and stores are all in the same place, as are the possible sources for more items and the data on orders in the supply chain system. This enables more productive interactions with customers or prospective customers (e.g., a store's sales representative may conduct a search and find that an item of interest is in transit or will be available at a certain date, thus suggesting a follow up action with regards to an interested customer (e.g., “ . . . we have a 4 of this hat on order, and it's scheduled to arrive in our store next week. Would you like me to call you when they arrive?”).

Similarly, the definition/description of a customer, and that customer's interactions with a brand or category of items, are the same no matter how they're viewed or accessed. For example, a call center interaction is attached to the same customer record as a store purchase is connected. Another example is that of a customer who puts an item onto his/her wish list online; such a customer can be identified when he/she comes into a physical store as having those items in his/her wish list; and, without extra work, a store associate can know whether that item is available in-store (since the product data is all coming from the same database and overall system).

In addition, the data specific to a customer's interaction with a webstore provides a source of behavioral information, ranging from the time spent on a page to a customer's reaction to product information or its presentation (e.g., how many of the alternate image views does the customer click on; do they always click on the product specifications as opposed to viewing the marketing copy?). When aggregated with the full set of product and customer data, this may provide a source of potential conclusions about a customer's relationship with a brand, where such conclusions which can extend beyond the web store. For example, a customer who invariably clicks on product specifications may be more fact- and data-oriented than a customer who views every product image first. That difference between customers can inform a store associate's or call center rep's approach to interacting with and selling to that customer.

Note that these features, advantages, and capabilities are not necessarily inherent in all multi-tenant or cloud-based systems. Rather, they arise from the single data source that the inventive system uses across all possible interactions, both internal and external (which results from implementing an integrated ERP, CRM, eCommerce, etc. based system that utilizes a single data source to provide synergistic and other benefits). Further, note that:
For eCommerce applications, having a single record associated with each item provides current information about availability, sales, pricing, location, etc. on a per item basis; and
In general, having a database store data that is accessed by multiple types of applications is significant in enabling discovery of relationships between factors across categories of data used in different applications (consumer spending, browsing, inventory levels, sales associates, messaging methods, methods of presenting information, etc.).

At a high level, the inventive system leverages a set of native records in a business data processing platform to create (in some cases using advanced analysis and rules-based management) a new set of records (the recommendations for action) that are distributed to various channels for implementing specific actions/workflows. Those new records appear in lists for human perception, and are run through an automated internal workflow process or definition to take the next step. Such native records may include (but are not required to include, or limited to only including):
Customer and all associated records;
Transaction Types;
Item Types;
Campaigns (both for acquiring data and for organizing activities); and
Future records being defined as a part of order management.

Below is an example of a table illustrating the type of data that may be used as inputs for the methods utilized by an embodiment of the invention—note that it is only representative and not intended to be comprehensive. Note that these data types are either native to the business data processing system/platform in which the inventive methods/processes are implemented (and sourced from a single location no matter the origin of the request), or they can be derived from those data and sourced from the same single location.

| | | | | Sample Data |
|---|---|---|---|---|
| Data Type | Item | Description | Source | (not comprehensive) |
| Product | Basic descriptive | Unstructured data | Item record | Name = ‘Lola’ satin |
| | data | that describes a | | shoe |
| | | product for a | | Description = This |
| | | human being. | | classic satin pump is a |
| | | Possibly useful | | great choice for a |
| | | for automated | | night out. Its mid- |
| | | systems with | | height heel lets you |
| | | natural language | | dance the night away, |
| | | processing. | | while the sleek satin |
| | | | | adds elegance to any |
| | | | | outfit. |
| Product | Categorized and | Structured data | Item record | Category = Women's Clothing |
| | faceted data | that allows automated | | Color = Red |
| | | associated with | | Designer = Generation N |
| | | other products | | |
| | | without natural | | |
| | | language processing | | |
| Product | Physical | Information that | Inventory record | Inventory |
| | management | describes the | | Supply Chain Insight |
| | data | product's physical | | |
| | | state. How many | | |
| | | are there? Where? | | |
| Supply | General supply | Information that | Various | Preferred shipment |
| Chain | chain data | describes the | | location = Warehouse 1 |
| | | entire system for | | Number of ship-to-store |
| | | getting a product | | orders = 50/day for store 23 |
| | | into the hands of a | | |
| | | buyer. | | |
| Customer | Basic customer | Basic account | Customer record | Name |
| | data | data for the | | Shipping address |
| | | customer. Most | | Billing Address |
| | | helpful information | | Birthday |
| | | tends to be around | | Payment rate. |
| | | shipping information | | Credit limit interaction |
| | | (address) and any | | (does customer hit the |
| | | additional | | limit?). |
| | | information | | Response to discount |
| | | volunteered by | | offers for early payment. |
| | | customer (birthday) | | Interaction with |
| | | | | accounts payable. |
| | | | | Credit scoring/rating |
| | | | | and change thereof. |
| | | | | Reference data change. |
| Customer | Interaction history | Ways in which the | Stored in | Customer support |
| | (non-product) | customer has | Customer | calls with no active |
| | | interacted with a | record, sourced | orders |
| | | brand that are not | via sales | Store visits that don't |
| | | associated with | associate | result in a purchase |
| | | any type of | recording, | Entry origin on |
| | | transaction. | automated | website. Pages |
| | | | recording, pixel- | viewed. Path traveled. |
| | | | based tracking | Key category |
| | | | on website | interested. Re-visited |
| | | | | or frequently visited |
| | | | | products, pages, or |
| | | | | categories. Reviews |
| | | | | and ratings activity. |
| | | | | Interaction patterns |
| | | | | with specific |
| | | | | components of a web |
| | | | | page (e.g., detailed |
| | | | | product data vs. |
| | | | | product imagery) |
| | | | | Coupons used. Sales |
| | | | | associates interacted with. |
| | | | | Retargeting response. |
| | | | | Other sites browsed. |
| | | | | Calls to CS. Emails to |
| | | | | CS. Help and knowledge base |
| | | | | access. Relationship |
| | | | | of CS contacts to |
| | | | | orders. Return rate. |
| | | | | Potential fraud rate. |
| Customer | Interaction history | All brand | Stored in | Store visit that results |
| | (product) | interactions | customer record | in a transaction |
| | | associated with a | and linked to | CS calls about a return |
| | | transaction | item records | Web sessions that |
| | | | | result in an add to cart |
| | | | | Add to wish list |
| Customer | Transaction | All product | Sales order, | All items purchased. |
| | history | transactions | associated with | Purchase modality |
| | | | customer record | (online, store, etc.) |
| | | | | Discounts used. Item |
| | | | | purchase frequency |
| | | | | and repeat. Product |
| | | | | categories purchased. |
| | | | | Product combinations |
| | | | | purchased. Order |
| | | | | fulfillment choices |
| | | | | (pickup in-store, fast |
| | | | | vs. slow shipping, |
| | | | | virtual goods, etc.). |
| Customer | Behavioral and | Data about the | Derived via | Browse behavior |
| | demographic | customer that | machine learning, | Age |
| | data | describes who | acquired via | Gender |
| | | they are (not just | census and/or | Household size |
| | | in relation to the | other data | Nationality |
| | | brand) and how | | |
| | | they act. | | |
| Customer | Attitudinal and | Describes a customer's | Derived via | Propensity to buy in |
| | predictive data | probably state of | advanced | category n = 75% |
| | | mind or desires. | analysis such as | Probability of |
| | | Generally derived | clustering, | responding to in-store |
| | | from other data. | predictive | suggestions in |
| | | | segmentation, | category y = 100% |
| | | | etc. | Data-driven customer |
| | | | | vs. visually-driven |
| | | | | customer |
| Customer | Campaign | Data describing | Sourced via | Campaigns received. |
| | Response | how a customer | Campaign record, | Goal of campaign vs. |
| | | reacts to the | Customer record. | desired behavior rate. |
| | | campaigns they | Derived via | Click-through rate on |
| | | receive. | campaign tracking | emails. Redeem rate |
| | | | mechanisms | on offers, and location |
| | | | | of redemption. |
| | | | | Connection between |
| | | | | items marketed and |
| | | | | purchased. |
| Sales | Sales associate | A list of attitudinal | | |
| Associate | recommendations | and predictive | | |
| | | data (e.g., sentiment | | |
| | | analysis) extracted | | |
| | | from customer | | |
| | | data, sourced from | | |
| | | the customers | | |
| | | assigned to the | | |
| | | sales associate. | | |

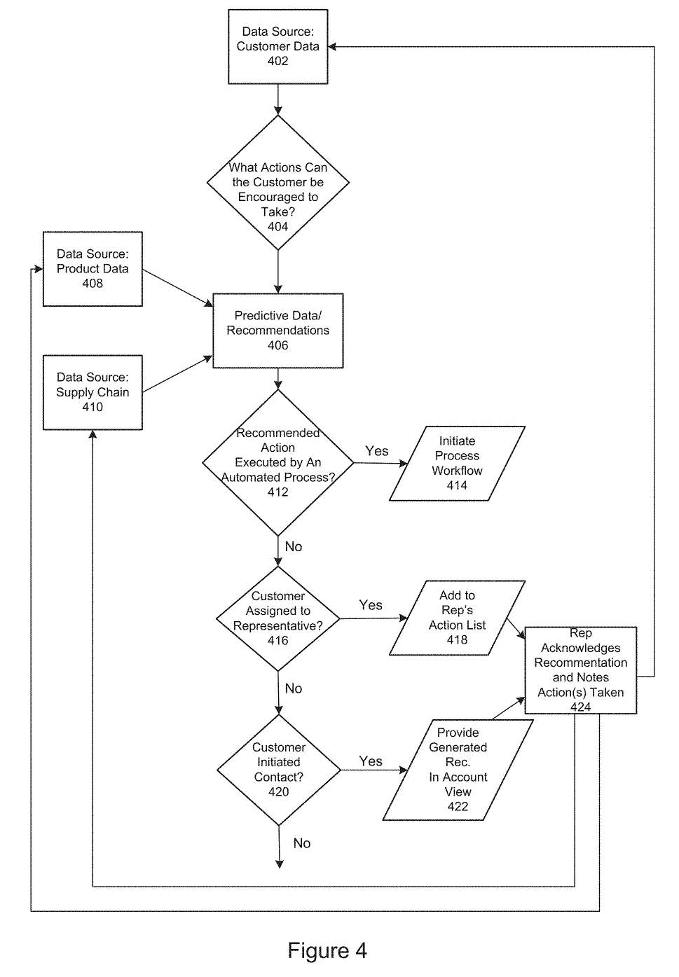

FIG. 4 is a flow chart or flow diagram illustrating aspects of a process, method, operation, or function that may be used when implementing an embodiment of the invention. Note that the data referenced in the flowchart refers to one or more of product or product related data, customer or customer related data, or business operations data, such as that identified in the example table (and/or its equivalents or corresponding data).

As shown in the figure, in one embodiment, Customer related data may be accessed from the database (as suggested by element 402, which may represent a database or other form of data storage element). This may include the data types referred to in the table, such as demographic data, data concerning the customer's previous responsiveness to marketing or advertising efforts, the customer's history of browsing and interacting (or failing to interact) with web-page elements, the customer's purchasing history, etc.

Once the data are accessed and made available for processing, the next step is to determine the behavior or behaviors that the vendor may be able to encourage a customer to take; these may include purchase of an item being browsed, purchase of an item similar to an item being browsed, purchase of an item that is often sold with the item being browsed, providing a response to a survey, providing a recommendation to a friend, completing an application for a loyalty or credit account, etc. (as suggested by step or stage 404). In some respects, this is part of determining what actions a vendor may be able to influence a customer to take based on acquired information about the customer's behaviors and their responsiveness to various ways of presenting information.

However, determining which of a set of possible behaviors (purchase, contact, arrange for delivery, visit physical store, etc.) that a customer could be encouraged to take is the one that should actually be encouraged may depend upon those that are most likely to be accepted by the customer, or are in the current interests of the vendor to cause to occur (because of inventory levels, an upcoming change in styles, etc.). This means that it is important to know what behaviors are available, which (if any) that the vendor would prefer to occur, and also how to most effectively communicate with the customer (based on data relevant to that customer and/or to one who is similarly situated in terms of demographics, browsing behavior, etc.) in order to induce a possible or desired behavior. Note also that the action or actions that a vendor might prefer to occur may depend to some extent on the current operational status of the vendor's business, where that status is reflected by the value of one or more of sales, sales velocity, inventory levels, profit margins, promotional campaigns, expected events, etc.

Information regarding how to most effectively communicate with a customer in order to cause a desired action, or which of a set of behaviors are those that are most likely to be caused to occur, may be determined by analyzing data regarding customer responsiveness to different information presentation methods or techniques. This may include analyzing data regarding a customer's page views, content selection, link activation, hover-time over a page element, follow-up actions after viewing a page, delay between viewing a page and taking an action, etc.

The types of customer behaviors that can be encouraged (and are likely to be successfully encouraged) may be determined using one or more of clustering, segmentation, sentiment analysis, or other predictive analytics techniques that are applied to data regarding customer actions and responsiveness to information (as suggested by step or stage 406). An important aspect of the inventive system and methods is the ability to not only leverage the data analysis techniques, but to do so in a manner which automatically ranks possible suggestions (e.g., based on the outcome of the decision or analytical techniques applied to the data) across the set of predicted outcomes, and as a result to deliver one or more reliable recommendations to a sales associate.

As shown in the figure, the sources of data that are processed in order to identify possible actions and generate recommendations may include product data (element 408) and supply chain data (element 410). This data may be obtained from the underlying database that contains the information reflecting the operational status of a business. Note that other sources of data may also be accessed and processed (e.g., sales/CRM data, HR data, loyalty group data, financial data, etc.) as part of generating a recommendation or a workflow, although these are not illustrated in the figure.

As an example, data regarding Shopper Sally may indicate that she is “very similar” (typically, this means along certain relevant dimensions) to other customers who purchased a given glassware set. This would be expected to make Sally more likely than the average customer to purchase that glassware set herself (note that this may be deduced from a form of collaborative filtering based on demographic characteristics, location, etc.).

However, Sally may have also shown a great deal of loyalty to a particular brand or designer, and that brand or designer is launching a limited edition collection of glassware that will be available in stores for only a limited time. In addition, Sally may also have recently gotten married, and received most, but not all, of the items on her gift registry list. In order to be most effective and provide the best customer service, a customer relationship system needs to efficiently and accurately determine which one of several possible desirable behaviors should be encouraged by a sales associate: purchase the glassware set, shop the brand's or designer's limited collection, or purchase an item on the registry list.

Additionally, the system also needs to determine the “best” (most likely to be effective) mechanism or method to drive the desired behavior(s). This may include one or more of a phone call to the customer, sending an email regarding the promotion, sending the customer a personalized email inviting her to come into the store, etc. For the greatest efficiency and effectiveness, this aspect of the overall process (i.e., determining the most likely to be effective or optimal workflow or communications approach) should also be automated.

Once one or more recommended actions have been identified or generated, the process illustrated in FIG. 4 may determine if one or more of those actions may be implemented by an automated process (as suggested by step or stage 412). If an automated execution is possible (as indicated by the “Yes” branch of step or stage 412), then the process may initiate a workflow to execute that action (as suggested by step or stage 414). Such actions may include, but are not limited to, generating a message for delivery by text or email, contacting a service representative and requesting that certain information be provided to the customer, providing/shipping a sample of a new product to the customer, automatically processing an adjustment to a customer's loyalty or credit account, etc.

If a recommended action cannot be executed by an automated process, then the process illustrated in FIG. 4 determines if the customer has been assigned or otherwise associated with a customer service representative (as suggested by step or stage 416). If the customer has been assigned or otherwise associated with a customer service representative (as suggested by the “Yes” branch of step or stage 416), then an action item or request for assistance may be added to that representative's action list (as suggested by step or stage 418). However, if the customer has not been assigned or otherwise associated with a customer service representative (as suggested by the “No” branch of step or stage 416), then the process determines if the customer initiated contact with the business (as suggested by step or stage 420). If the customer did initiate contact (as suggested by the “Yes” branch of step or stage 420), then one or more recommendations may be provided to the customer as part of their overall view into their account (as suggested by step or stage 422). In either case (i.e., the customer being previously assigned or associated with a service representative, or not being previously assigned or associated), a service representative may acknowledge the generated recommendation and note any actions that have been taken (as suggested by step or stage 424). This may have an impact on the data stored regarding the products, the product inventory, or the customer behaviors (as suggested by the connections between step or stage 424 and elements 402, 408, and 410).

While some companies may have attempted to create a form of comprehensive customer relationship system, the resulting system is typically an effort drawing on data from many sources, data which do not agree or share formats, and data which cannot be effectively leveraged in real-time or near real-time. In contrast, an advantage of the inventive system and methods is in leveraging the unified data of a suite of applications to deliver these and other customer relationship benefits without any kind of customization, batch jobs, etc.

Note that the data mining/analysis/optimization processes utilized need not take only direct customer revenue into account in determining a recommendation and/or workflow. This is because the vendor/company goals may include maximizing customer lifetime value, maximizing inventory and product efficiency, or creating a feeling for the customer that the entire company is operating as their personal shopper (and therefore increasing goodwill and customer engagement with the business), among others.

The recommendations may be generated/determined/evaluated in a number of ways, including but not limited to:
Leverage clustering, segmentation, and other predictive analytics techniques to identify or predict likely associations, such as:
   Customers similar to this customer who purchased certain items;
   Customers who bought certain items who also purchased other items;
   How well this customer is likely to respond to upsell efforts;
   If the customer is likely to increase their engagement level if certain actions are taken (e.g., the frequency or content of emails is modified, the customer receives a phone call, the customer is encouraged to engage on a specific social media outlet, etc.); and
   If the customer is likely to respond more to appeals based on a type of benefit (e.g., logical: materials used, manufacturing process, and country of origin vs. emotional: brand name, celebrity association, etc.).
Generating pre-defined recommendations, based on business related data, such as:
   An out of stock item is back in stock;
   An out of stock item may be comparable to other items that are available;
   A previously purchased item has a matching or coordinating item; or
   The customer has an item on his/her wish list that is on sale, or is overstocked, and it would be beneficial to the company to bring this situation to the customer's attention.

As noted, inputs to the data analysis and decision processes may include customer data, product data, supply chain data, or financial operating data, among others. One aspect of the inventive system and methods is to not only leverage the techniques to generate recommendations, but to do so in a manner which ranks possible suggestions by taking into account the predicted outcomes and ordering them according to a rule or heuristic (such as by the likelihood of success in producing a desired outcome).

In cases where the behavior is one that requires a human being to take action (e.g., a phone call is the recommended action, or an email is recommended but the content requires human input), the system may trigger an alert containing the relevant data and inform the person who needs to take the action of the situation. In cases where the action can be implemented automatically, the system may instead initiate and perform that action. In all cases, the action taken will be associated with that customer's profile data for future assessment of effectiveness and determination of any new actions to consider.

Embodiments of the inventive system and methods combine access to data at the company level (i.e., vendor, merchant, platform-tenant or account, etc.) and at the customer level (i.e., the end user of an eCommerce platform, a vendor's customers, etc.) with one or more of configured rules or heuristics, data mining techniques, statistical analysis techniques, machine learning techniques, or other relevant analytical methods to process that data and determine actionable recommendations for companies, customer service representatives, and customers. Embodiments of the invention enable vendors/companies/tenants to better leverage a single data source containing data regarding every one of their customers' interactions to make better decisions about how they interact with their customers. In the case of an eCommerce platform, the single data source includes a single definition of a product or service, no matter how information about the product or service is accessed, and a single definition of a customer, no matter how that data is accessed, along with the customer's browsing behavior/purchase transaction history.

A goal of the inventive system and methods is to leverage the data available on multiple customer communications channels (e.g., customer support, email, web, and in-store) as well as company data (e.g., inventory, new product introductions, promotional offers, sales, profit margins) to implement an effective guided customer care process for sales representatives. This is valuable because, as recognized by the inventors, sales representatives typically don't have access to all of the data they may need to make the best decisions about what their valued customers may wish to purchase. Instead, they are forced to cobble together information from sales records, personal notes, and company notifications regarding products.

However, the inventive system is one in those multiple sources of data are not only collected together and processed, but one which can provide guided steps to cultivate the relationship with a shopper. The generated recommendations and suggested workflow can provide sales representatives with recommendations for products to offer customers that optimize both the customer's happiness and the company's profits.

Note that as mentioned, one of the benefits from having a single source of “truth” that represents an integrated view of product availability, location, profit margin, product characteristics or metadata (and which is enabled by the underlying data store and structure) is that it ensures more accurate and satisfactory customer services. By having an integrated source of data, embodiments of the invention can generate recommendations based on different factors or on more complex combinations of factors than conventionally available from systems that isolate CRM, ERP, eCommerce data in separate data stores. Further, recommendations may be based on real-time business metrics and operational conditions, along with customer data.

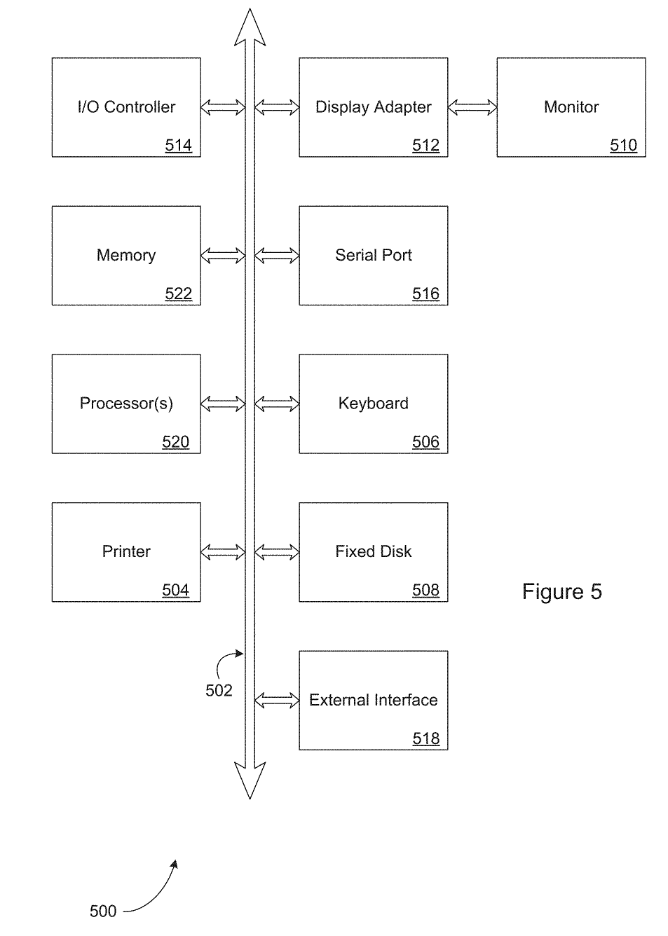

In accordance with one embodiment of the invention, the system, apparatus, methods, processes, functions, and/or operations for enabling effective use of customer and business operations data to encourage desired customer behaviors may be wholly or partially implemented in the form of a set of instructions executed by one or more programmed computer processors such as a central processing unit (CPU) or microprocessor. Such processors may be incorporated in an apparatus, server, client or other computing or data processing device operated by, or in communication with, other components of the system. As an example, FIG. 5 is a diagram illustrating elements or components that may be present in a computer device or system 500 configured to implement a method, process, function, or operation in accordance with an embodiment of the invention. The subsystems shown in FIG. 5 are interconnected via a system bus 502. Additional subsystems include a printer 504, a keyboard 506, a fixed disk 508, and a monitor 510, which is coupled to a display adapter 512. Peripherals and input/output (I/O) devices, which couple to an I/O controller 514, can be connected to the computer system by any number of means known in the art, such as a serial port 516. For example, the serial port 516 or an external interface 518 can be utilized to connect the computer device 500 to further devices and/or systems not shown in FIG. 5 including a wide area network such as the Internet, a mouse input device, and/or a scanner. The interconnection via the system bus 502 allows one or more processors 520 to communicate with each subsystem and to control the execution of instructions that may be stored in a system memory 522 and/or the fixed disk 508, as well as the exchange of information between subsystems. The system memory 522 and/or the fixed disk 508 may embody a tangible computer-readable medium.

It should be understood that the present invention as described above can be implemented in the form of control logic using computer software in a modular or integrated manner. Based on the disclosure and teachings provided herein, a person of ordinary skill in the art will know and appreciate other ways and/or methods to implement the present invention using hardware and a combination of hardware and software.

Any of the software components, processes or functions described in this application may be implemented as software code to be executed by a processor using any suitable computer language such as, for example, Java, Javascript, C++ or Perl using, for example, conventional or object-oriented techniques. The software code may be stored as a series of instructions, or commands on a computer readable medium, such as a random access memory (RAM), a read only memory (ROM), a magnetic medium such as a hard-drive or a floppy disk, or an optical medium such as a CD-ROM. Any such computer readable medium may reside on or within a single computational apparatus, and may be present on or within different computational apparatuses within a system or network.

All references, including publications, patent applications, and patents, cited herein are hereby incorporated by reference to the same extent as if each reference were individually and specifically indicated to be incorporated by reference and/or were set forth in its entirety herein.

The use of the terms “a” and “an” and “the” and similar referents in the specification and in the following claims are to be construed to cover both the singular and the plural, unless otherwise indicated herein or clearly contradicted by context. The terms “having,” “including,” “containing” and similar referents in the specification and in the following claims are to be construed as open-ended terms (e.g., meaning “including, but not limited to,”) unless otherwise noted. Recitation of ranges of values herein are merely indented to serve as a shorthand method of referring individually to each separate value inclusively falling within the range, unless otherwise indicated herein, and each separate value is incorporated into the specification as if it were individually recited herein. All methods described herein can be performed in any suitable order unless otherwise indicated herein or clearly contradicted by context. The use of any and all examples, or exemplary language (e.g., “such as”) provided herein, is intended merely to better illuminate embodiments of the invention and does not pose a limitation to the scope of the invention unless otherwise claimed. No language in the specification should be construed as indicating any non-claimed element as essential to each embodiment of the present invention.

Different arrangements of the components depicted in the drawings or described above, as well as components and steps not shown or described are possible. Similarly, some features and sub-combinations are useful and may be employed without reference to other features and sub-combinations. Embodiments of the invention have been described for illustrative and not restrictive purposes, and alternative embodiments will become apparent to readers of this patent. Accordingly, the present invention is not limited to the embodiments described above or depicted in the drawings, and various embodiments and modifications can be made without departing from the scope of the claims below.

What is claimed is:

1. A system for generating a recommendation of a product for a customer or a suggested action for the customer to take, and for providing guidance to a customer service representative regarding the presentation of the recommendation or suggested action to the customer, comprising:
a database or data store containing a plurality of records, the plurality of records including records corresponding to customer interactions with an organization providing the products, and records corresponding to the business operations of the organization;
a processor programmed with a set of instructions, wherein when executed by the processor, the instructions cause the system to
access data representing a status of an aspect of the organization's business operations from the database or data store;
access data representing a customer's interactions with the organization from the database or data store;
process the accessed data, including implementing a decision process to generate the recommendation or the suggested action;
generate a workflow or process for interacting with the customer to enable the organization's representative to present the recommendation or suggested action to the customer, and
present the workflow or process to the organization's representative.

2. The system of claim 1, wherein the data representing a status of an aspect of the organization's business operations includes data representing one or more of product inventory, inventory location, product sales, product characteristics, revenue, or profit margin.

3. The system of claim 1, wherein the data representing a customer's interactions with the organization includes data representing one or more of the customer's demographic characteristics, the customer's current or previous on-line browsing activities, a status of an order for a product, the customer's previous purchasing activities, the customer's loyalty group memberships, or the customer's responsiveness to different means of contact or presentation of information.

4. The system of claim 1, wherein the recommendation or suggested action relates to a product or service, and further wherein the decision process is based on one or more of a rule set, statistical analysis, pattern matching, sentiment analysis, or application of a machine learning technique.

5. The system of claim 1, wherein the workflow is presented to the organization's representative while the representative is interacting with the customer.

6. The system of claim 5, wherein the organization's representative is a sales representative or a customer service representative.

7. The system of claim 2, wherein the data representing the status of an aspect of the organization's business operations is real-time data reflecting the current state of the organization's business operations.

8. The system of claim 1, wherein the recommendation is presented to the customer during the customer's on-line browsing session.

9. The system of claim 1, further comprising one or more business related data processing applications installed in the system, wherein the one or more business related data processing applications include one or more of an enterprise resource planning (ERP), customer relationship management (CRM), human resources management (HR), or eCommerce application.

10. A method for generating a recommendation of a product for a customer or a suggested action for the customer to take, and for providing guidance to a customer service representative regarding the presentation of the recommendation or suggested action to the customer, comprising:
accessing data representing a status of an aspect of the organization's business operations from the database or data store;
accessing data representing a customer's interactions with the organization from the database or data store;
processing the accessed data, including implementing a decision process to generate the recommendation or the suggested action;
generating a workflow or process for interacting with the customer to enable the organization's representative to present the recommendation or suggested action to the customer; and
presenting the workflow or process to the organization's representative.

11. The method of claim 10, wherein the data representing a status of an aspect of the organization's business operations includes data representing one or more of product inventory, inventory location, product sales, product characteristics, revenue, or profit margin.

12. The method of claim 10, wherein the data representing a customer's interactions with the organization includes data representing one or more of the customer's demographic characteristics, the customer's current or previous on-line browsing activities, a status of an order for a product, the customer's previous purchasing activities, the customer's loyalty group memberships, or the customer's responsiveness to different means of contact or presentation of information.

13. The method of claim 10, wherein the recommendation or suggested action relates to a product or service, and further wherein the decision process is based on one or more of a rule set, statistical analysis, pattern matching, sentiment analysis or application of a machine learning technique.

14. The method of claim 10, wherein the workflow is presented to the organization's representative while the representative is interacting with the customer.

15. The method of claim 10, wherein the organization's representative is a sales representative or a customer service representative.

16. The method of claim 11, wherein the data representing the status of an aspect of the organization's business operations is real-time data reflecting the current state of the organization's business operations.

17. The method of claim 10, wherein the recommendation is presented to the customer during the customer's on-line browsing session.

18. The method of claim 10, wherein data representing the status of an aspect of the organization's business operations or data representing a customer's interactions with the organization is generated by one or more business related data processing applications, wherein the one or more business related data processing applications include one or more of an enterprise resource planning (ERP), customer relationship management (CRM), human resources management (HR), or eCommerce application.
